(19) United States
(12) Patent Application Publication
(10) Pub. No.: US 2012/0278195 A1
(43) Pub. Date: Nov. 1, 2012

(54) METHOD FOR LOCATING A PROVIDER AND A PROVIDER LOCATING SYSTEM

(76) Inventor: Douglas JOSEPH, Boise, ID (US)

(21) Appl. No.: 13/458,794

(22) Filed: Apr. 27, 2012

Related U.S. Application Data
(60) Provisional application No. 61/479,813, filed on Apr. 27, 2011.

(51) Int. Cl. G06Q 30/00

(52) U.S. Cl. 705/26.2

(57) ABSTRACT

A method for locating a provider based on, among other things, proximity to a user requesting the provider. Providers that are available to respond to the request are determined and data regarding one or more of the available providers is sent to the user.

### RELATED APPLICATIONS

The disclosure claims benefit to U.S. Provisional Application No. 61/479,813, filed Apr. 27, 2011, the disclosure of which is hereby incorporated by reference in its entirety.

### FIELD OF THE DISCLOSURE

The present disclosure is directed to a system that facilitates connecting users with providers of goods and services based on their proximity, their availability or by a combination of both their proximity and availability to one another as determined by geo location technology.

### BACKGROUND

Locating available service providers can be a difficult and/or time consuming task. Many types of service providers, such as painters, carpenters, landscapers, pavers, and so forth, often perform work at locations that are remote from their place of business. This can make it difficult to contact these service providers during the work day. Often a potential customer must leave a voice message and wait for the provider to call back. The provider may have work scheduled for days or weeks in advance, and thus even when a customer is able to contact the service provider, the customer may find that the provider is not able to respond in a timely fashion to a work request. The difficulty of locating service providers that are available to respond to a request can be especially problematic when immediate service is needed.

There remains a need for an improved process of locating service providers that is convenient and less time consuming. In addition, a process for efficiently locating service providers that are available to respond to a customers request within a desired time frame would be desirable in the art.

### SUMMARY

An embodiment of the present disclosure is directed to a method for locating a provider. The method comprises receiving profile data from a plurality of providers. The profile data includes registration data associated with mobile electronic devices for the providers. A unique provider profile comprising the profile data is created and the provider profile data is stored on a database. A unique identifying key code is allocated for each of the mobile electronic devices. The unique identifying key code allows the provider mobile device to communicate with the provider locator system. Updated location coordinates for the provider are periodically received from the mobile devices. A request is received from a user for locating a provider. The user is prompted to select a type of provider from a plurality of different categories of providers. The user is prompted to enter an address of a location where service is to be performed or a service delivered, the user's contact information and a description of services or goods being requested. The user's location is determined by latitude and longitude coordinates. The profile data is accessed and a list of potential providers is determined based on the type of provider requested. The list of potential providers is sorted by proximity to the user based on the updated location coordinates available for the potential providers. At least one of the potential providers is notified of the request. Providers that are available to respond to the request are determined. Data regarding one or more of the available providers is sent to the user.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitutes a part of this specification, illustrates an embodiment of the present teachings and together with the description, serves to explain the principles of the present teachings.

FIGS. 1-9 illustrates a process for connecting users with providers of goods and services, according to an embodiment of the present disclosure.

FIG. 10 illustrates an overview of the process of FIGS. 1-9, according to an embodiment of the present disclosure.

FIG. 11 illustrates the information process flow between the user and service provider and the various technology components, according to an embodiment of the present disclosure.

FIG. 12 illustrates a Mobile Electronic Device Application function in maintaining service providers' location and availability status, according to an embodiment of the present disclosure.

FIG. 13 is an exemplary screen shot from a provider mobile device application.

FIGS. 14-17 are exemplary screen shots of the Locate Express website as may be seen by a user.

FIG. 18 illustrates an embodiment employing a third party push notification server.

It should be noted that some details of the figure have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawing. In the following description, reference is made to the accompanying drawing that forms a part thereof, and in which is shown by way of illustration a specific exemplary embodiment in which the present teachings may be practiced. The following description is, therefore, merely exemplary.

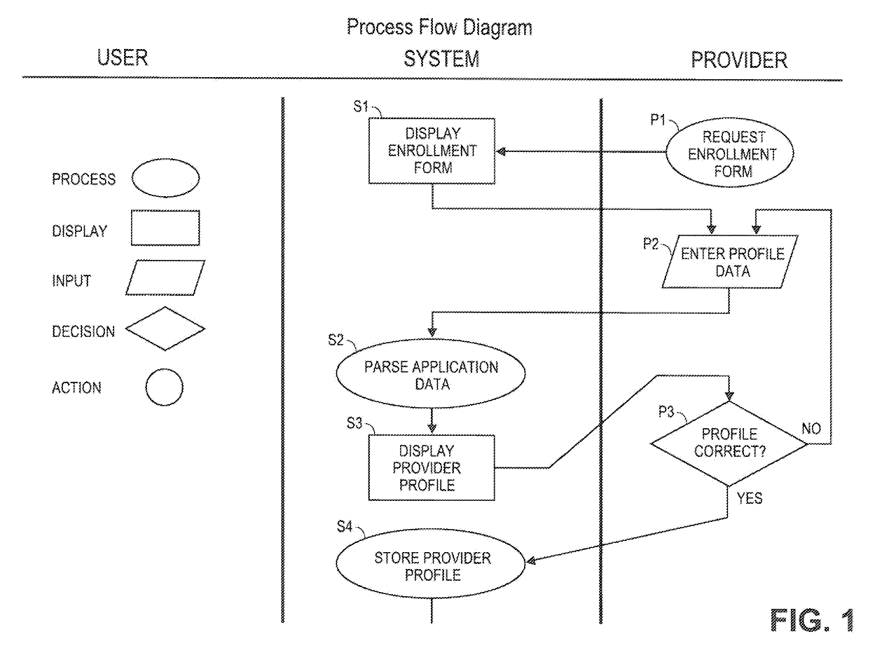

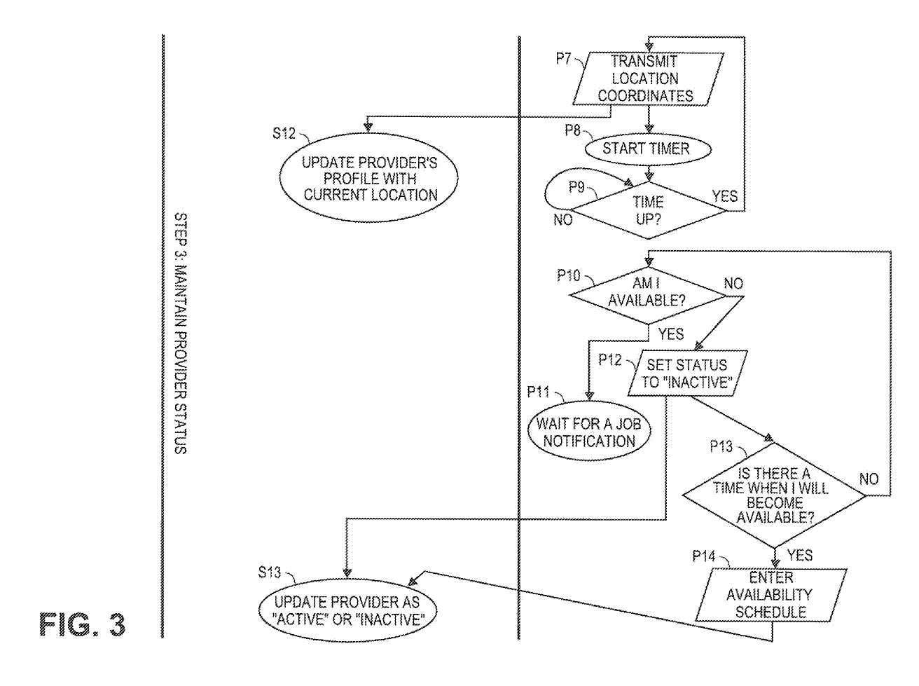

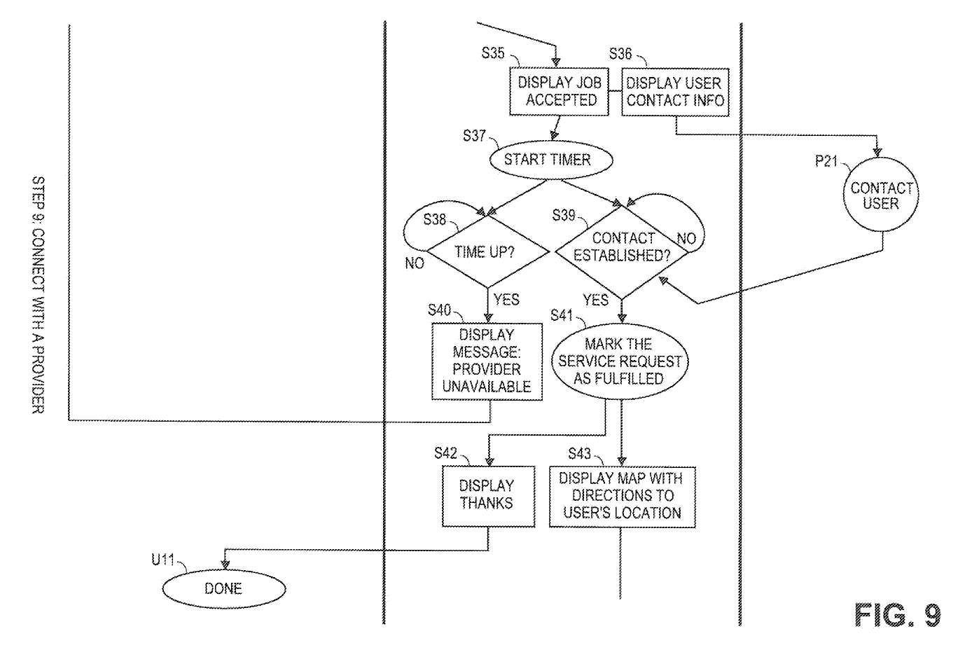

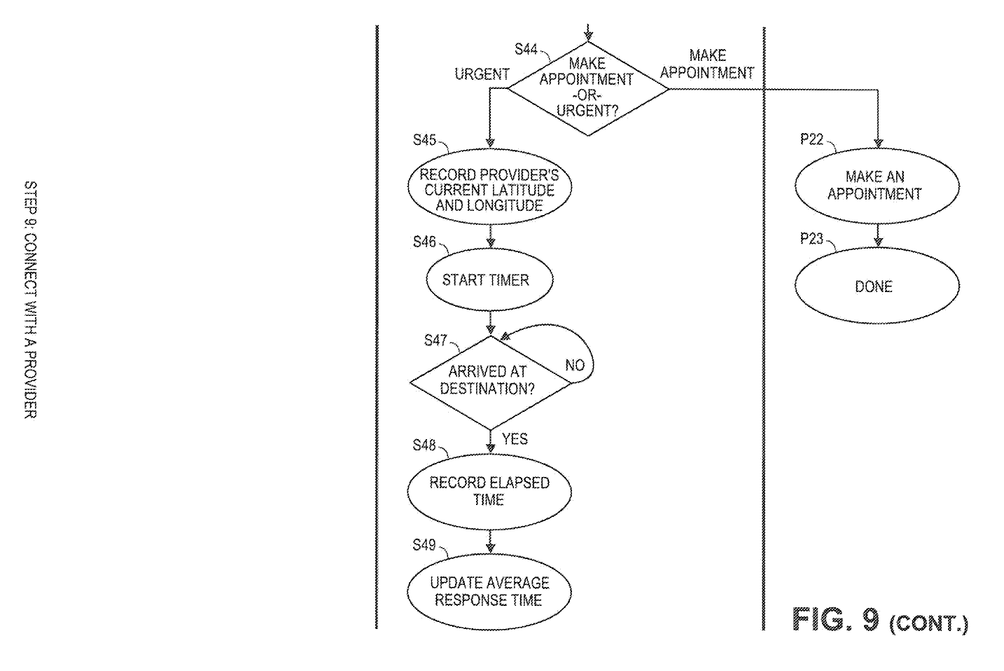

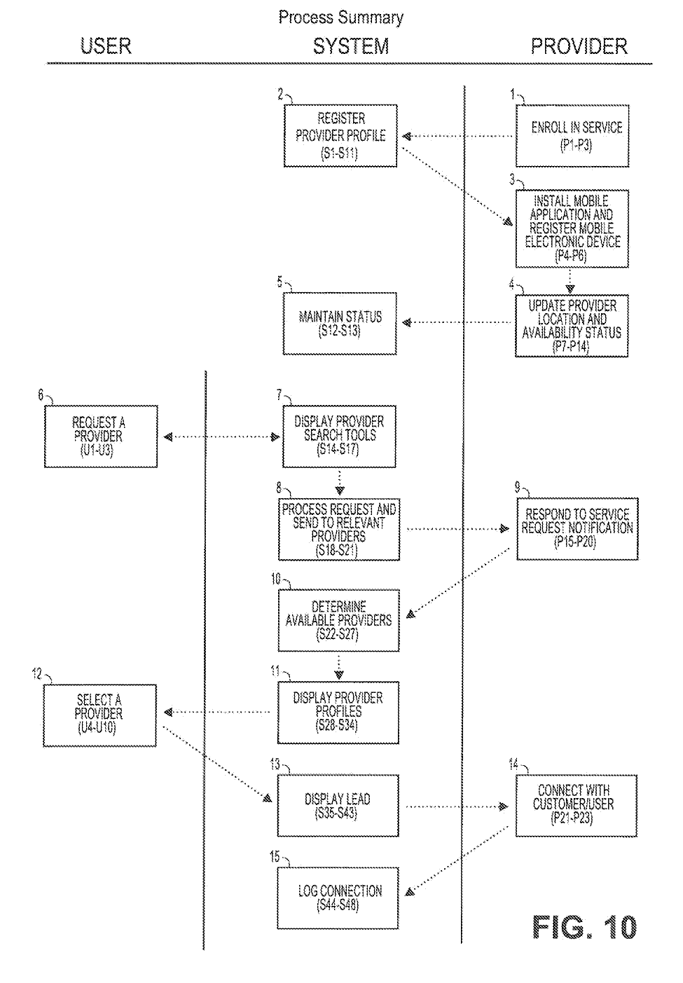

The Process Flow Diagram, which is shown in FIGS. 1-9, illustrates the interaction between the user, the system, and the provider, according to an embodiment of the present disclosure. FIG. 10 illustrates an overview of the process of FIGS. 1-9. The FIG. 10 summary utilizes the alpha-numeric identifiers from FIGS. 1-9. For example, FIG. 10, numeral one “enroll in service” (P1-P3) corresponds to P1-P3 in FIGS. 1-9.

The processes of the present disclosure can include some or all of the following steps. For example, some of the steps described below may be carried out in a process implemented by the system, while other of the steps may be carried out by either a service provider or a user of the system, as is described and illustrated more fully herein. The process steps described herein include:

Obtain provider profiles

Register provider's mobile device

Maintain provider's status

Request a provider

Service request notification of providers

Determine available providers

Display available provider profiles

Select a provider

Connect with a provider

### Step 1: Obtain Provider Profiles

The process starts when an interested service provider (P1) requests an electronic enrollment form from the system (S1), as illustrated in FIG. 1. The provider inputs data into the displayed electronic enrollment form (P2). The data fields on the form can include, any desired information regarding the providers, such as the provider's services performed and goods sold, personal name, business name, address, phone numbers, e-mail addresses, website addresses, insurance, licensing and bonding information, years in business and other pertinent information about the provider and his business. The system parses the data from the electronic enrollment form (S2) and displays the data for review (S3). The provider may be given the opportunity to validate the information (P3) and the data is stored in a database (S4) creating a unique provider's profile.

### Step 2: Register Provider's Mobile Electronic Device.

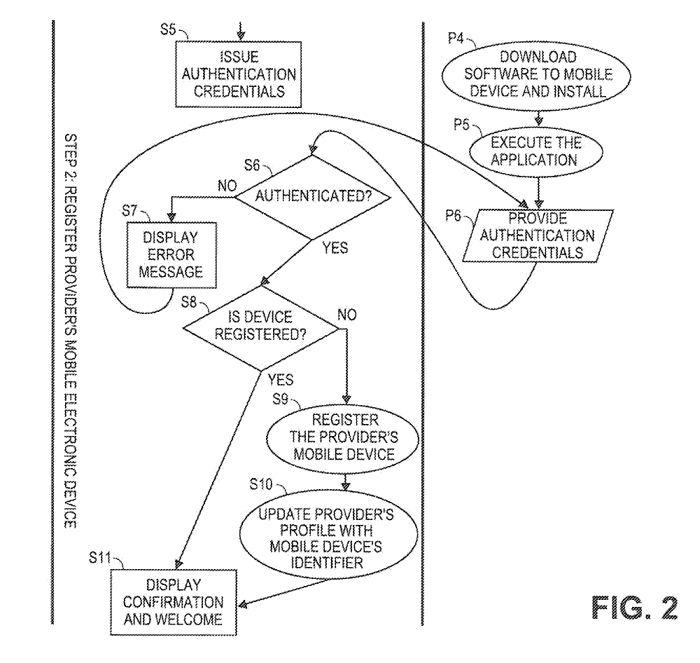

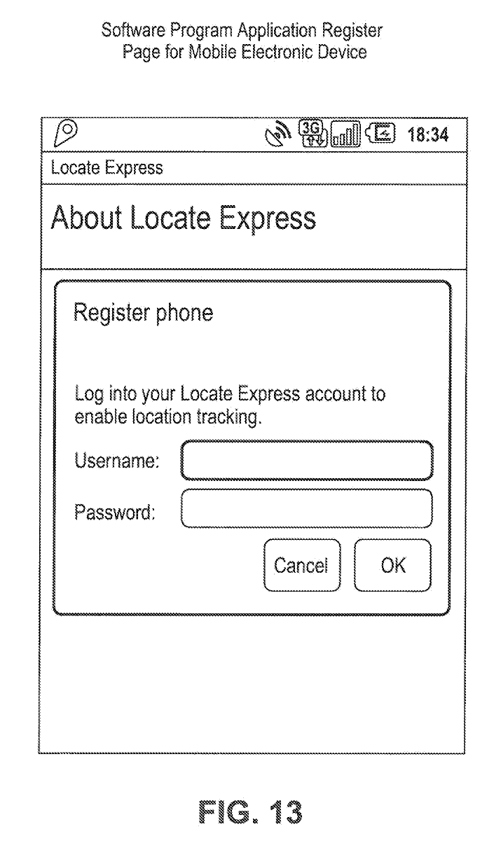

Once a unique provider's profile is established the provider receives a username and password (S5) to register the provider's mobile electronic device, as illustrated in FIG. 2, according to an embodiment of the present disclosure. The provider downloads a software program application to his mobile electronic device (P4). To activate the application (P5), the provider authenticates with the system (P6, S6, S7) and registers his mobile electronic device (S8). A screen shot of an example App Register Page is shown in FIG. 13. The system allocates a unique identifying key code for the registered mobile electronic device (S9). The system updates the provider's profile in the database with the mobile electronic device's identifying key code (S10) and confirms the application registration (S11).

In an embodiment, after registration, the provider receives a unique system URL that when used will identify his company as an originating source of a service request. Company information and advertising messages may be included in addition to the service request data anytime the personalized and/or unique URL is used to make a service request. The URL can be used when the provider or the provider's clients request to locate another service provider within the network.

### Step 3: Maintain Provider's Status

The provider's electronic mobile device software program application can now communicate with the system by, for example, sending real time latitude and longitude coordinates for locating, sending and receiving electronic notifications, hyper-linking phone numbers and e-mail addresses, mapping locations and directions, time stamping, or logging and archiving electronic actions (P7, S12, P8, P9). Updated location coordinates for the provider can be transmitted to the system periodically, with the time interval between updates being determined by a timing loop and/or when the phone changes location significantly (P9).

Providers can manually toggle their active or inactive status on and off or schedule specific active states by date and time. One exemplary process of inputting provider activity status is shown at P10, P11, P12, P13 and P14. The providers' updated profile with current location and active status can be stored by the system (S12, S13).

In an embodiment, a provider's active status can revert to inactive if the last reported location (from the tracking application) to the database has not been updated within a specified time period prior to a user's service request. Any suitable specified time period can be set, such as, for example, a time period ranging from 2 hours to 48 hours, such as 4 hours, 8 hours, 12 hours, 24 hours, or 36 hours or more. This can help to avoid situations in which a customer request is sent to providers that are not close to a customer, or whose locating technology has toggled off or whose mobile device app is not running properly. For service providers in the system who prefer to be located from a static location, such as an office address, the system can designate the static locations as permanently active without the need for location reporting updates.

If the system cannot find a predetermined amount of service providers who have “fresh” reported location updates within the specified time period of the service request, then the system can look for providers in later time tranches determined by historical location reporting times preceding the service request in order to “fill the bucket” with enough service providers. In an embodiment, the system can allow service providers to test their mobile device app's functionality cycling through a complete service request to familiarize the service provider with the procedure and how to properly accept and respond to a user's service request For example, a “provider test” category can be created for service providers in the system to run test requests that will be received solely on their electronic mobile device. The system determines a field in the service request form, such as a phone number, that matches the testing mobile electronic device in the database so that only the identified phone would receive the test notification of the service request.

### Step 4: Request a Provider

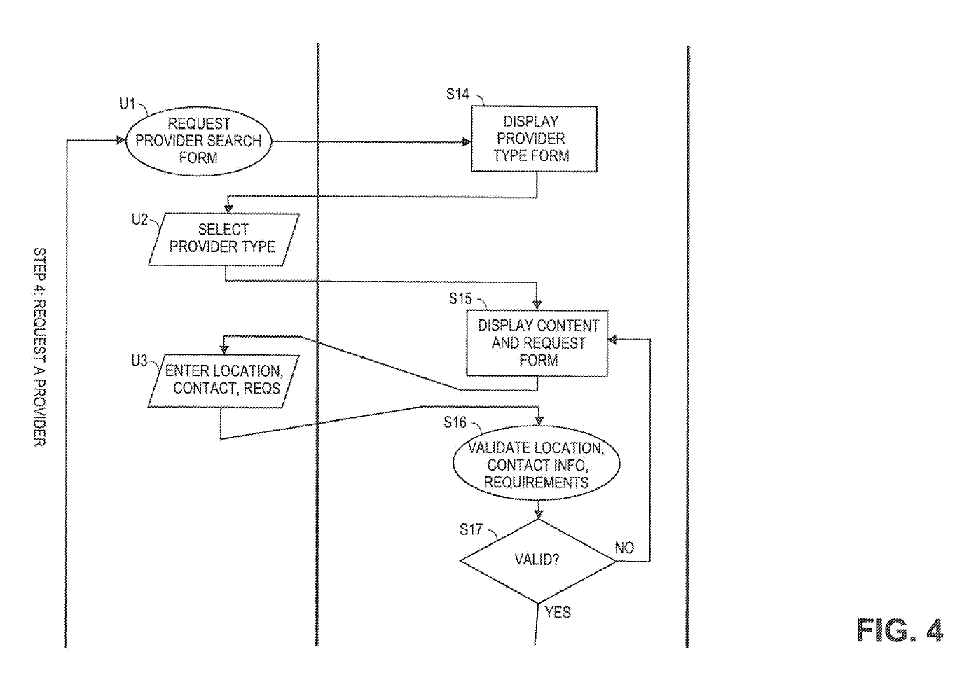

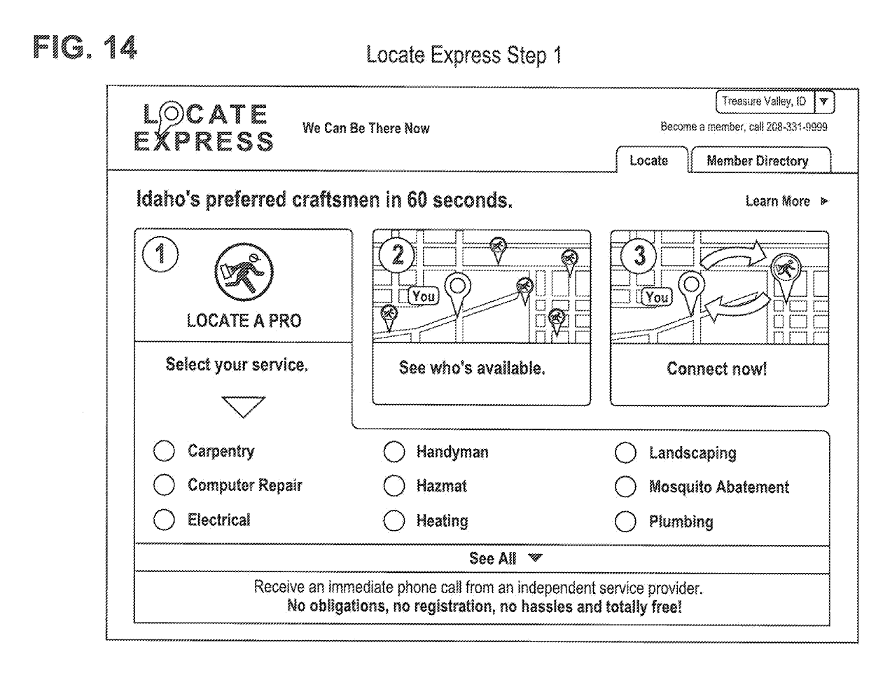

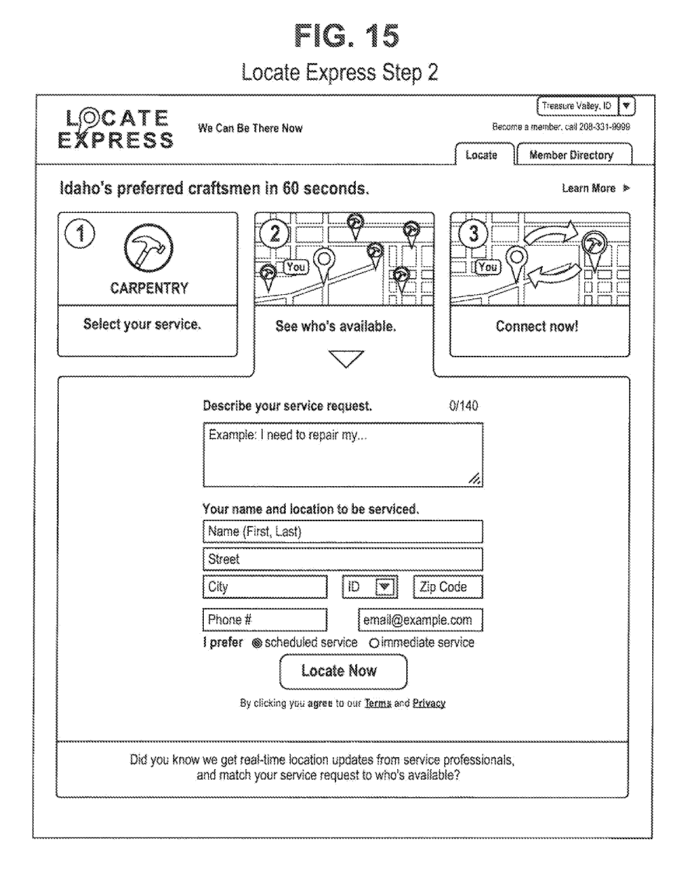

Referring to FIG. 4, a user (U1) looking for a local service provider starts the process by reviewing a list of service categories sent from the system (S14) to be displayed on the user's computer or mobile device. A screen shot of an example page that could be displayed to a user is shown at FIG. 14. A user selects the desired service category (U2) and the system sends the user a contact and request form (S15). A screen shot of an example page is shown at FIG. 15. The system prompts the user to input data (U3) that can be used by the system to determine a match with potential service providers. In an embodiment, the user contact and request form can provide fields and dialog boxes for the user to input information for the system to determine the user's location by latitude and longitude coordinates, provide information about the user's service needs, and how the user can be contacted. Such information may include, for example, user name, user address, service location address, phone number, e-mail address, and a description of services or goods requested. The system may provide the user the option of specifying requests for either immediate service or for non-immediate service. Non-immediate service may be further distinguished by time intervals of when the requested work is needed, such as today or tomorrow, this week, this month or flexible, or by a specified date. The request form may have other options to specify user service needs, such as a quote or estimate request, a service question or other service related requests.

In an embodiment, the system can give users the option to refine a search selection for service providers by affiliation with one or more organizations. For example, users can be given the option to limit the search to service providers affiliated with an organization of choice, rather than to search all service providers in the data base. In yet another embodiment, an algorithm could be employed to weight all service providers by organization. For example, the system could search for service providers affiliated with one or more preferred organizations.

When the user submits the contact and request form, the system may validate the address via an address verification and mapping application (S16). If the user address or service location cannot be validated (S17), the system redirects the user back to the user contact and request form (S15) to input valid data.

If desired, the system can allow a user to choose to use a computer or mobile electronic device's geo-location service in lieu of a physical address. Methods for using geo-location to supply a physical address are well known in the art. In an embodiment, after the system validates proper addresses and any required input fields the system proceeds to Step 5.

### Step 5: Service Request Notification to Providers

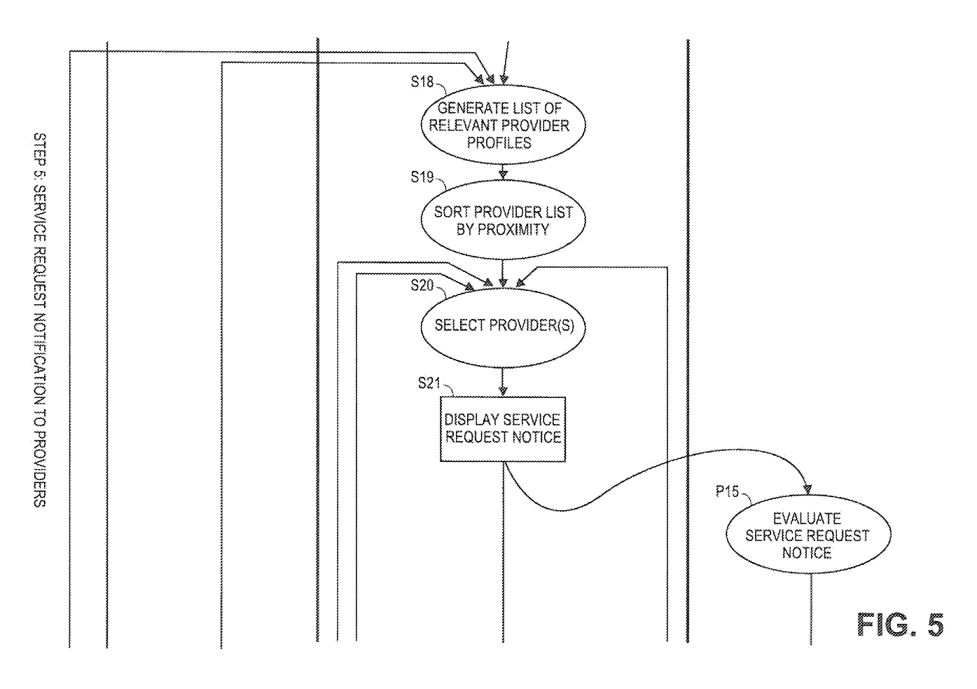

Referring to FIG. 5, the system parses the user contact and request data provided in Step 4 and creates a list of providers that match the user's selected service category (S18). The system can then sort the provider list by proximity (S19) to the user or user's service location as determined by the most current reading of latitude and longitude coordinates (P7, S12, P8, P9) of providers' registered electronic mobile devices stored in the database.

In an embodiment, the list of service providers selected can be limited by distance to the user. For example, a geo-fence can be employed that limits the distance from a customer that a request can be received. If no providers are within the specified geo-fence radius then the system will not send any notifications and can simply time out or give-up. In such cases, a notification can be sent to the user informing him that no provider could be found.

Employing a geo-fence can involve determining with the computer system whether a service provider's last registered location in the database was within a specified radius (range) of the customer's location. Both the geo-fence radius and proximity can be considered, so that the system can determine which service providers are within range of a customer's location and are closest in proximity to the customer. In this manner, the system can determine a prioritized order of service providers within range of customer's location to dispatch requests based on proximity to a user.

In an embodiment, the system has the ability to refine a search selection for service providers by affiliation with a particular organization. For example, as discussed above, the search results can be limited to search providers affiliated with a specified organization.

In embodiments, as discussed above, where an algorithm is employed to weight service providers by organization, service providers in the data base that are affiliated with a preferred organization could be assigned a weighting that would give them preference over other non-affiliated providers. For example, the affiliated service providers could be given preference by the system in the search selection process, displayed first in the search results and/or could be displayed in a manner that makes the user aware of which businesses are affiliated and which are non-affiliated with the preferred organization.

The system determines the active status of providers from the provider database (S13), and selects from the set of active providers (S20). Service request notifications can be sent (S21, P15) to one or more of the electronic mobile device applications of providers with an active status on the matched list (S18).

Request notifications can include, but are not limited to, the type of service request, a description of the service needed, the provider's distance from user or service location, and if the request is for immediate or non-immediate service. The sequence or basis for notification from the parsed and sorted provider list can be determined from any of the methods described below, or combinations thereof.
Sending notifications to all providers all at the same time.
Sending notifications to all providers incrementally. Incrementally refers to notifications staggered by predetermined time intervals.
Sending notifications to all providers in incremental batches. Batches refer to a predetermined number of providers who will receive the notification at the same time.
Sending notifications to providers within a predetermined distance from the user/service location incrementally, or all at once. For example, notifications can be simultaneously sent to a plurality of providers (e.g., five at a time) who are within a specified radius of a customer. The plurality of providers are given a specified time to respond (e.g., 30 seconds to 5 minutes or more, such as 1 minute). Once the specified time lapses, the providers who responded (e.g., three out of the five) are sorted by proximity to the customer. The closest provider of the three that responded to the customer can then be chosen as the available provider, and their provider profile is sent to the user. Alternatively, profiles for all three of the providers that responded can be sent.
Sending notifications to providers by proximity from the user/service location incrementally. For example, the first notification would be sent to the closest provider to the user/service location. After a predetermined time, the next closest provider will receive the next notification and so on, until someone actually responds. Often, the closest provider, although getting a request first, may actually not be the first to respond as being available. In these cases, a provider further down in the queue can be the provider that actually is first made available and responds to the customer. Thus, which providers are displayed as being available to the user can involve determining if the provider meets two separate criteria: first, that the provider has a sufficiently recent location update and second, that the provider responds positively to the request.
Sending notifications to providers sorted by proximity in incremental batches. For example, the closest batch of providers to the user or service location receives notifications simultaneously. The next closest batch of providers receive requests simultaneously at a predetermined time after the first batch of notifications have gone out.
Sending notifications to both providers sorted by proximity and providers who had a pre-determined availability schedule by time and day, all at once.
Sending notifications to both providers sorted by proximity and providers who had a pre-determined availability schedule by time and day, incrementally.
Sending notifications to providers sorted by proximity and providers who had a pre-determined availability schedule by time and day, in incremental batches.
Sending notifications to providers sorted by proximity and availability all at once.
Sending notifications to providers sorted by proximity and availability incrementally.
Sending notifications to providers sorted by proximity and availability in incremental batches.
Sending notifications to providers based on other available information such as response times, customer ratings or other data relevant information.

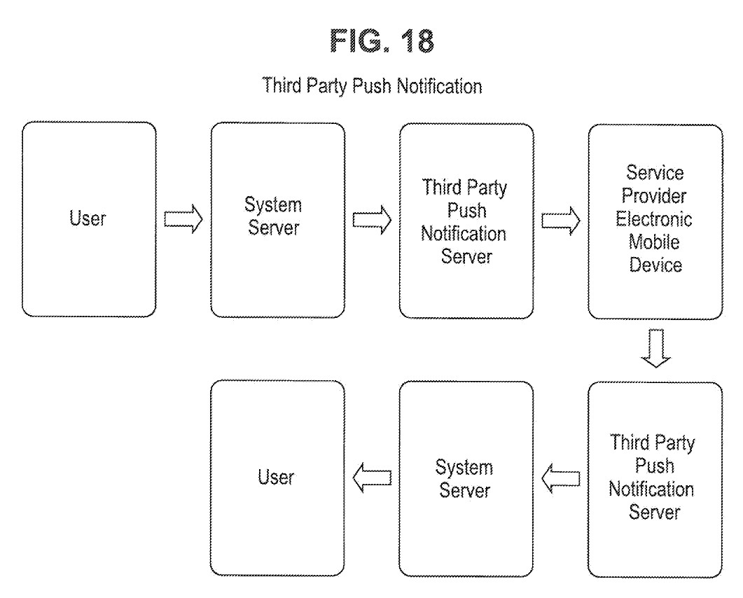

An embodiment of the process employs a third party push notification system as an intermediary for sending ‘and receiving notifications between users, the system's server and the providers’ electronic mobile devices. As shown in FIG. 18, information received from users is sent to the system's server which in turn is sent from the systems' server to a third party push notification server. The third party push notification server then forwards information to the provider's electronic mobile device. This process works in reverse when communicating from the providers' electronic mobile device to the third party push notification server to the system's server to the user.

### Step 6: Determine Available Providers

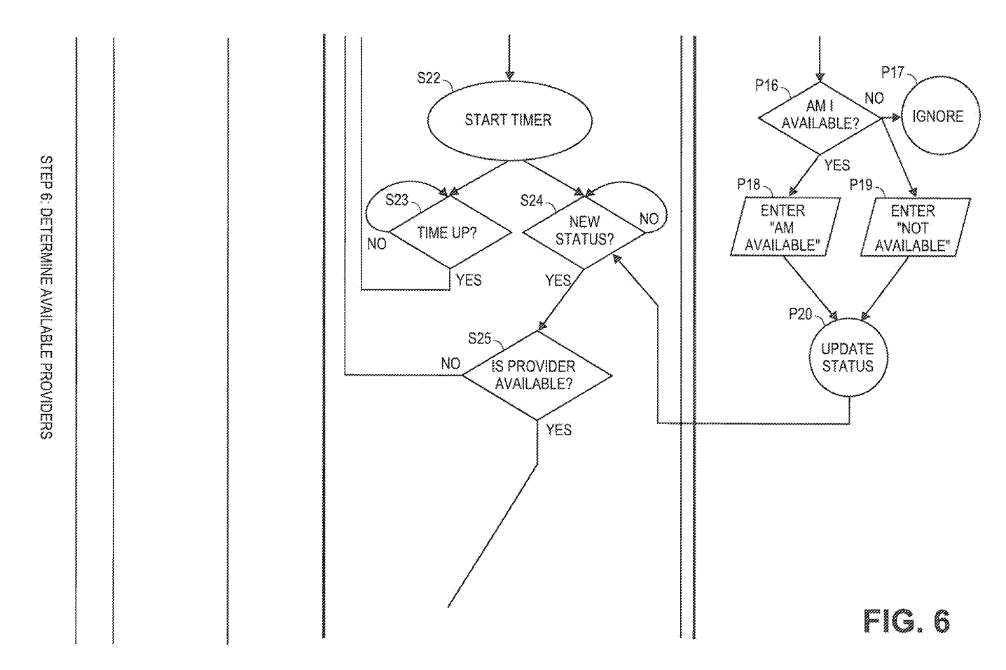

In order for a provider's profile to be reviewed by a user the provider may make himself “available.” Referring to FIG. 6, providers who receive a service request notification have three options to respond to the service request (P16). First is to accept the user service request. By doing so, the provider updates his status to “available.” (P18). Second is to decline the user service request. By doing so, the provider's status is “unavailable.” (P19). A service provider has a third option which is to ignore the service request (P17). For this option, an ignored response is similar to a declined response.

In an embodiment, a timer begins when a service request notification is sent to a provider (S22). Each provider receiving a service request notification has a time limit to respond to the request notification. If a provider does not respond within the allotted time, the alert status (S24) may time out (S23). For example, if a provider fails to accept a service request within the designated time, the system may not allow the provider to accept the request by updating his status to “available” (S25).

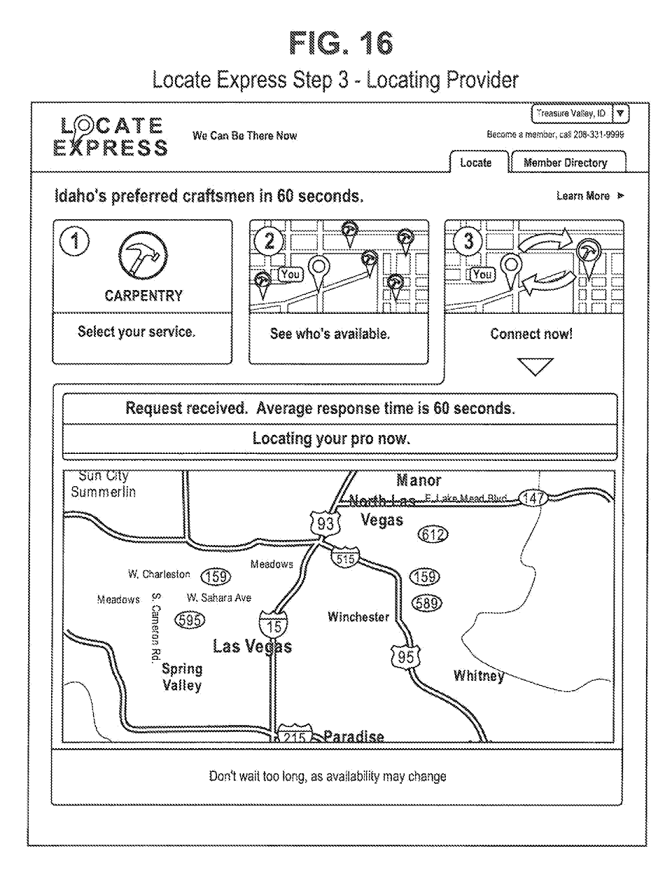

While the system is identifying available providers, the user is notified that their request was received and the system is searching for an available provider, as illustrated in the example screen shot of FIG. 16. If desired, a motion “spinner” may be displayed signifying the process is working. In addition to or in place of a motion spinner, a digital stopwatch or other digital timing device can display in real-time how long a customer waits to receive a response from an available service provider. If no providers who received a service request notification are available to accept the service request, or do not accept the request within a designated time, the system will time-out and the user will view a message that no providers are available.

### Step 7: Display Available Provider Profiles

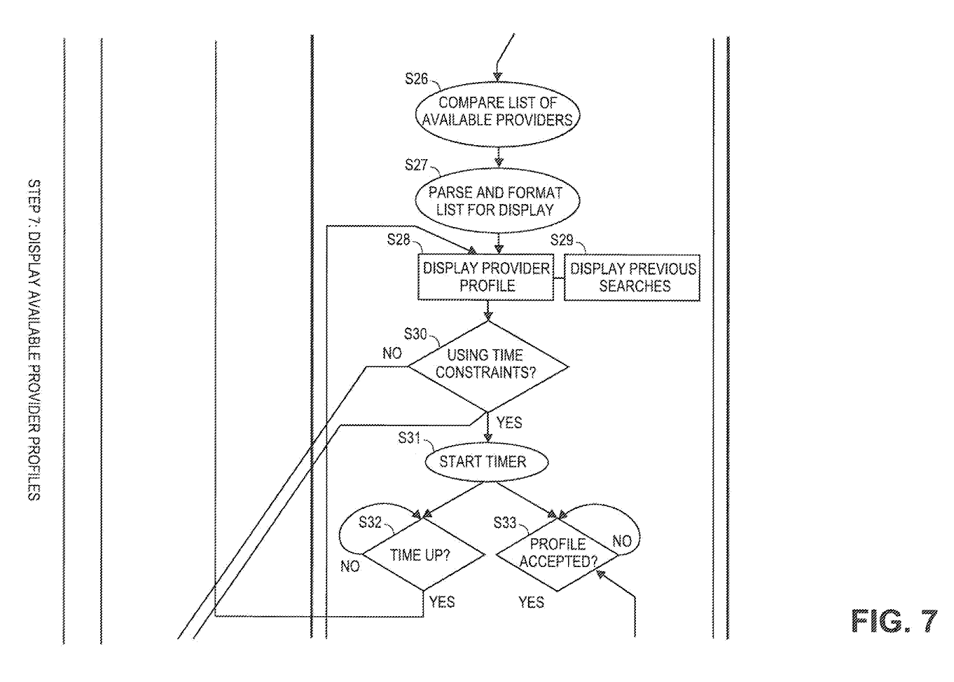

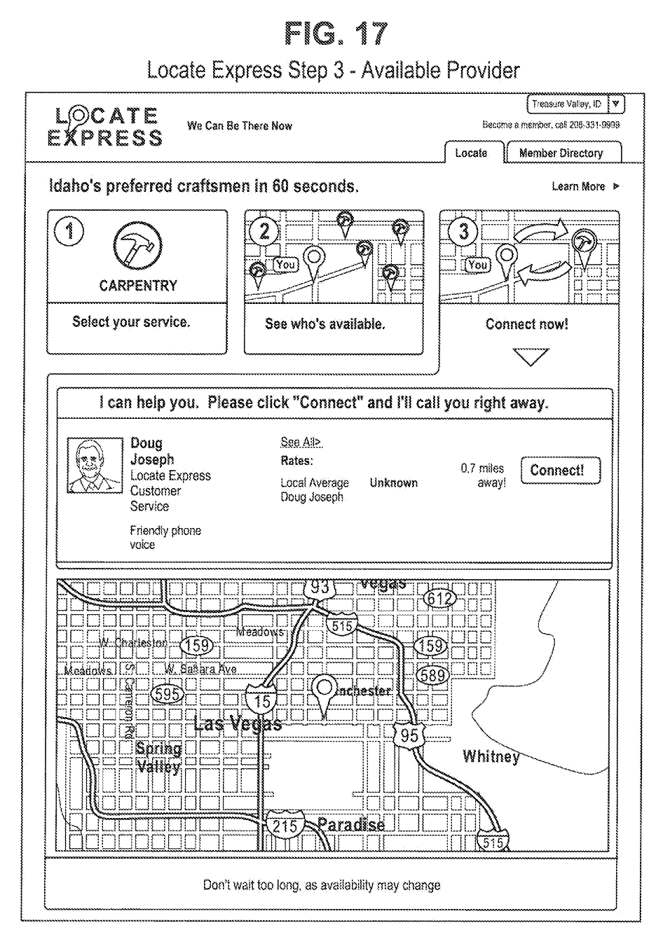

Referring to FIG. 7, as the system updates the status of available providers, a list of available providers is created (S26) and displayed for the user (S28). A screen shot of an example page displaying an available provider is illustrated at FIG. 17.

In an embodiment, profiles of individual providers can be displayed as well as their proximity to the user. The providers' proximity to users can be displayed in, for example, meters or miles, either graphically or visually on a map, or a combination of both. Other information may be included in the displayed profile such as rates, testimonials, phone numbers and other pertinent information about the provider and his company.

The system can parse and display the list of available providers (S27) in any desired manner, such as one, individual provider at a time, a batch of providers at a time or all providers at a time. The system can arrange the list in various ways. Some examples are by first responders, prioritized by proximity to user or service location, highest rated providers, by provider history, response time or other determined criteria or any combination thereof.

In an embodiment, the system can implement a timer (S30, S31, S32) to induce the user to respond in selecting a provider when a list of available providers appears for the user's review. If a user does not respond by selecting a service provider within the allotted time (S33), the system may time out (S32).

### Step 8: Select a Provider

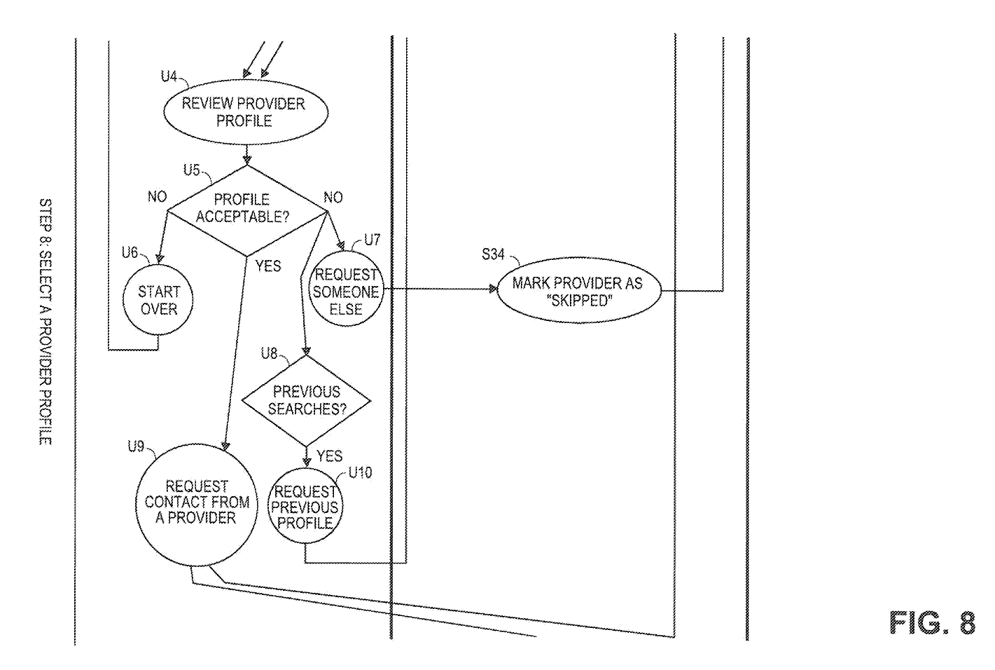

Referring to FIG. 8, the user reviews the displayed provider profiles (U4). In one example, the user has the option of returning to Step 4 to start the process over (U6), or selecting another profile (U5, U7, U8, U10). Alternatively, the system may not give the user the option of starting over, but may only allow the user the option of selecting a provider from the displayed profiles. In either case, when the user takes the action of selecting a provider (U9), the user's contact information can be sent as an electronic notification to the selected provider (S35, S36).

In an alternate embodiment, the user can simply contact the provider from information that may be included on providers' profiles, such as phone numbers or e-mail addresses. The user may contact one or more available providers using his preferred contact method, such as by phone, e-mail or sms text message.

Step 9: Connect with a Provider

The selected service provider receiving the user's contact information confirms the job win by contacting the user (P21). One possibility is for the provider to press the user's phone number hyperlink, causing the provider's phone to call the user's number. This contact finalizes the service request ticket and acceptance of the job (S41). A map with the user's address and directions may display on the provider's electronic mobile device (S43). In an embodiment, the system can implement a timer to induce a response from the provider. If the service provider does not respond to the user in the allotted time, the system may time out. (S37, S38, S39, S40).

If desired, the system can then display a message to the user indicating that the system is finished communicating with the user, such as, for example, by thanking the user for using the website (S42). In an embodiment, providers who had responded, but were not selected by the user, receive a courtesy notification to their electronic mobile device informing them the job went to someone else providing closure to the job ticket.

In an embodiment, at the time of job acceptance, if the user has requested immediate service (S44), the provider's latitude and longitude coordinates are recorded in the database (S45) and a time clock begins (S46). When the service provider arrives at the user's or service location (S47), he takes action to stop the time clock. The time and latitude and longitude coordinates are then recorded in the database and the system records the elapsed time (S48) and updates the service provider's average response time (S49). Alternatively, the time, latitude and longitude data are not collected and the service provider's average response time is not calculated.

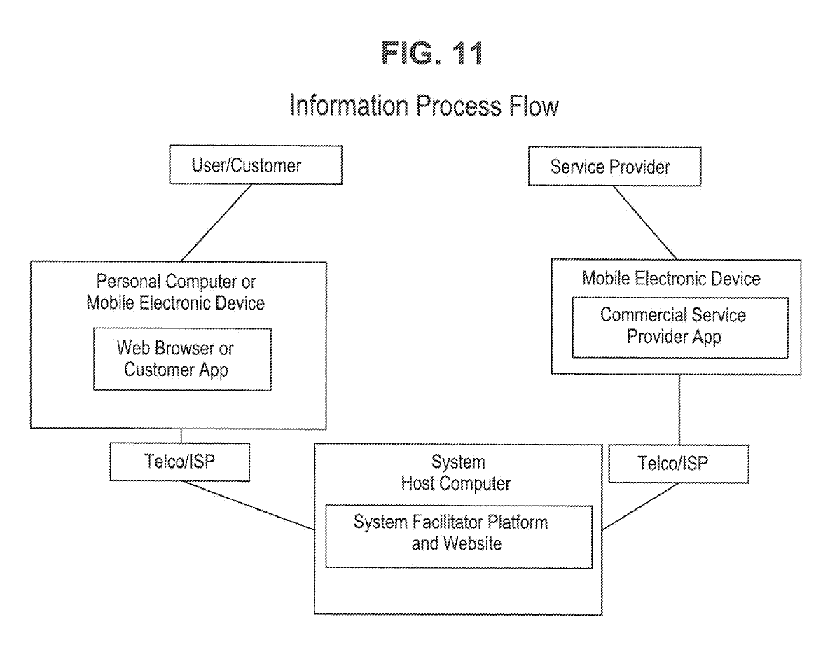

FIG. 11 demonstrates the information process flow between a user/customer and a service provider. The user can access the system from any computer or mobile electronic device through a web based browser or a consumer app developed for mobile devices such as smart phones and tablet computers.

The transmission of data goes from the user's browser or application through a telephone company and/or Internet service provider to the system's host computer. The host computer then forwards the data through a telephone company and/or Internet service provider to the service provider application on the provider's mobile electronic device. The service provider receives the user's information and responds accordingly. The response from the service provider back to the user can occur by transmission of data in the reverse order of FIG. 11, or by another suitable means, such as by direct contact with the user via telephone or email.

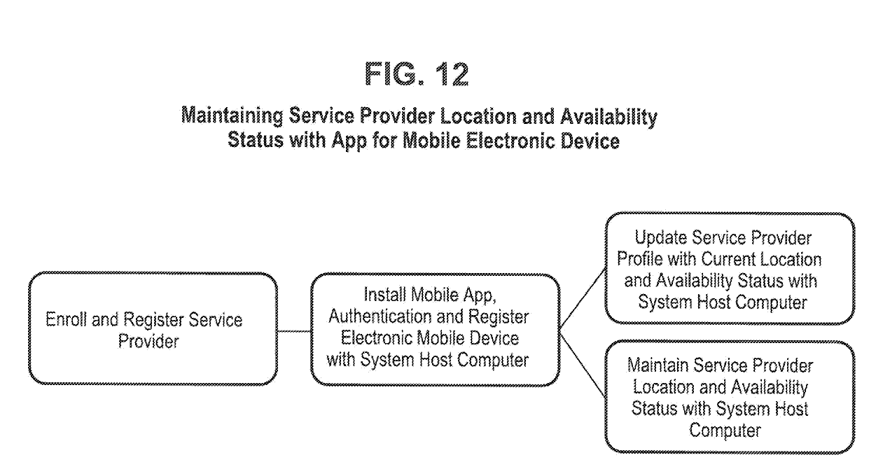

FIG. 12 demonstrates how a service provider's location and availability status can be maintained. First a provider enrolls and registers with the service. The provider can then install the mobile application on his electronic mobile device and authenticate and register the electronic mobile device with the system's host computer. The system updates the service provider's profile and the mobile application sends data to the host computer updating the provider's location and availability. The system maintains the service provider's status periodically with location and availability updates sent from the mobile application installed on the electronic mobile device.

The processes above have been discussed in terms of locating a service provider. Categories of service providers can include, but are not limited to, carpenters, computer repair, electrical, handyman, hazmat, heating, landscaping, mosquito abatement and plumbing. Still other categories can include appliance repair, bark blowers, book keeping, carpet and flooring, carpet cleaning, cooling, drain cleaning, drywall, duct cleaning; fences, patios and decks; flood, fire & mold; gutters, hardwood flooring, lawn care, painting, paving, payroll services, real estate agents, remodel, roofing, sprinkler installation and repair, tax services, tile, tree services, window install or repair, windshield and ding repair, auto repair, backflow valve, bike repair, blinds, business coaching, cabinets, catering, chimney cleaning, chiropractor, computer networking, concrete, cooling, courier, curbing, dental, dog services, excavation, fertilization, financial Services, fireplace services, flood and water cleanup, disaster repair, flooring, carpet install, garage door, graphic design, holiday lights, home inspection, home theater, house cleaning, insulation, insurance, interior design, junk hauling, knife sharpening, land surveyors, legal, locksmith, massage therapy, masonry, mortgage loans, moving, pest control, piano tuning, power washing, private investigators, property management, satellite installation, search engine optimization, security alarm systems, snow removal, solar power, taxi, towing, website design, window cleaning, window repair, windshield repair and so forth. However, the processes of the present disclosure can also be used for finding local producers of goods, such as local farmers, or any other provider that delivers goods directly to the consumer.

The processes described herein and illustrated in the flowcharts represent embodiments of the present disclosure that may be implemented using any suitable computer readable instructions, as would be readily understood by one of ordinary skill in the art. For example, each of the blocks in the process diagrams FIGS. 1-10 may represent in whole or in part a module, segment, or portion of code that comprises one or more executable instructions to implement the specified logical function(s). The instructions can be stored on any suitable computer readable, non-transitory media.

Also, the processes of the present disclosure can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many non-transitory media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

The present application is also directed to a provider locator system, such as, for example, the host computer shown in FIG. 11. The provider locator system can comprise an instruction execution system such as a processor or an ASIC (Application Specific Integrated Circuit). The instruction execution system can fetch or obtain the logic from computer-readable media and execute the instructions contained therein, where the instructions can be any of the processes for locating a provider as discussed herein.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method for locating a provider using a provider locator system, the method comprising:
receiving profile data from a plurality of providers, the profile data including registration data associated with mobile electronic devices for the providers;
creating a unique provider profile comprising the profile data and storing the provider profile data on a database;
allocating a unique identifying key code for each of the mobile electronic devices, the unique identifying key code allowing the provider mobile device to communicate with the provider locator system;
periodically receiving updated location coordinates for the provider from the mobile devices;
receiving a request from a user for locating a provider;
prompting a user to select a type of provider from a plurality of different categories of providers;
receiving a selected provider type from the user;
prompting the user to enter the user's contact information, a description of services or goods being requested and an address of a location of where service is to be performed or where the goods are to be delivered;
determining the user's location by latitude and longitude coordinates;
accessing the profile data and determining a list of potential providers based on the type of provider requested;
sorting the list of potential providers by proximity to the user based on the updated location coordinates available for the potential providers;
notifying at least one of the potential providers of the request;
determining providers that are available to respond to the request; and
sending data regarding one or more of the available providers to the user.

2. The method of claim 1, wherein the provider is a service provider.

3. The method of claim 1, wherein the categories of providers comprise at least one service type chosen from carpenters, computer repair, electrical, handyman, hazmat, heating, landscaping, mosquito abatement or plumbing.

4. The method of claim 1, wherein the profile data comprises information associated with at least one of: a provider's services, a provider's goods for sale, personal name, business name, address, phone numbers, e-mail addresses, website addresses, insurance, licensing and bonding information, or years in business

5. The method of claim 1, further comprising providing the user an option of specifying either immediate service or delivery, or non-immediate service or delivery before notifying the at least one provider of the request.

6. The method of claim 1, further comprising selecting providers having an active status from the provider database; and sending request notifications to the electronic mobile devices of the one or more selected providers.

7. The method of claim 6, further comprising providing an option for the selected providers to update their status in order to indicate that they are available to respond to the request.

8. The method of claim 6, wherein a list of the available providers is created and provided to the user.

9. The method of claim 1, further comprising sending the user profiles for the available providers, the provider profiles including the proximity of the providers to the user.

10. The method of claim 1, wherein a third party push notification system is employed as an intermediary for sending and receiving notifications to the users and the electronic mobile devices of the providers.

11. The method of claim 1, further comprising receiving selection data for a desired provider from the user; and providing an option to the desired provider to contact the user.

12. A computer readable medium comprising a set of instructions for carrying out the method of claim 1.

13. A system for locating a provider, the system comprising an instruction execution system and a computer readable medium comprising a set of instructions for carrying out the method of claim 1, the instruction execution system configured to access and carry out the instructions on the computer readable medium.

14. A method for locating a provider using a provider locator system, the method comprising:
receiving profile data from a plurality of providers, the profile data including registration data associated with mobile electronic devices for the providers;
creating a unique provider profile comprising the profile data and storing the provider profile data on a database;
allocating a unique identifying key code for each of the mobile electronic devices, the unique identifying key code allowing the provider mobile device to communicate with the provider locator system;
periodically receiving updated location coordinates for the provider from the mobile devices;
receiving a request from a user for locating a provider;
prompting a user to select a type of provider from a plurality of different categories of providers;
receiving a selected provider type from the user;
prompting the user to enter the user's contact information and a description of the services or goods being requested;
prompting the user to enter either a physical address of a location where service is to be performed or goods are to be delivered, or to select an option of using a geo-location service in lieu of a physical address,
prompting the user to optionally limit a search selection of providers to providers affiliated with a desired organization;
determining the user's location by latitude and longitude coordinates;
accessing the profile data and determining a list of potential providers based on the type of provider requested and, if the user so chose, based on affiliation with the desired organization;
sorting the list of potential providers by proximity to the user based on the updated location coordinates available for the potential providers;
notifying at least one of the potential providers of the request;
determining providers that are available to respond to the request; and
sending data regarding one or more of the available providers to the user.

15. The method of claim 14, wherein a provider's active status will revert to inactive if the provider's location coordinates have not been updated within a specified time period prior to a user's request.

16. The method of claim 14, wherein if location coordinates have not been updated within the specified time period for a desired number of providers, then searching for additional providers having a last registered location report within a second specified qualifying time that is greater than the first specified qualifying time.

17. The method of claim 14, further comprising providing an option for the provider to qualify as having a static address; and if the provider qualifies as having a static address, creating a single location state wherein the static address is always eligible to receive user requests.

18. The method of claim 14, further comprising limiting the distance from which a provider can accept a request from a user.

19. The method of claim 14, further comprising receiving selection data for a desired provider from the user; and providing an option to the desired provider to contact the user.

19. The method of claim 14, further comprising receiving selection data for a desired provider from the user; and providing an option to the desired provider to contact the user.

20. The method of claim 14, wherein the provider is a service provider.
